(19) United States
(12) Patent Application Publication
(10) Pub. No.: US 2008/0011771 A1
(43) Pub. Date: Jan. 17, 2008

(54) Flexible Vending Machine

(75) Inventors: Jurgen Roekens, Steenokkerzeel (BE); Willy Van Esch, Grez-Doiceau (BE); Laurent Houtsaeger, Antwerpen (BE)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/456,577

(22) Filed: Jul. 11, 2006

(51) Int. Cl. G07F 11/26

(52) U.S. Cl. 221/253

(57) ABSTRACT

A vending machine for dispensing a number of containers. The vending machine may include a shelf system and a vend belt system positioned about the shelf system.

### TECHNICAL FIELD

The present invention relates generally to vending devices and more particularly relates to a vending machine with a rotating shelf system and a vend belt system so as to provide flexible vending.

### BACKGROUND OF THE INVENTION

Generally described, vending machines are typically designed for containers of a predetermined shape or size. As such, the introduction of a differently shaped or sized container may be an operational struggle. Specifically, physical adjustments may be required such as the addition of shims, column spacers, and the like so as to accommodate the new shape or size. These additional parts, however, may call the reliability of the overall vending machine into question. As a result, most vending machines are often not ideally equipped for such newly shaped or sized containers. Such a drawback therefore may inhibit the introduction and design of new products and/or limit the access of a consumer to such new products or new product designs.

There is a desire, therefore, for a vending machine that can accommodate containers of any shape, size, or even material without requiring extensive adjustments. The vending machine also should be reliable regardless of the nature of the containers used therein.

### SUMMARY OF THE INVENTION

The present application thus describes a vending machine for dispensing a number of containers. The vending machine may include a shelf system and a vend belt system positioned about the shelf system.

The vending machine further may include a number of shelf systems. Each shelf system may include a number of shelves. The shelves may have a variable distance therebetween. The shelf system may include a belt with the shelves attached thereto. The shelf system may include a number of belts. The shelf system may include a top end and a bottom end. The shelves may extend substantially horizontally when traveling from the top end to the bottom end of the shelf system and substantially vertically when traveling from the bottom end to the top end.

The vend belt system may include a vend belt. The vend belt system may include a pulley system for maneuvering the vend belt. The pulley system may include a first wheel, a second wheel, and a pulley belt. The vend belt system may include a stop positioned about the vend belt.

The present application further describes a method of vending at least one container. The method may include the steps of loading the container onto a vend belt in a closed position, retracting the vend belt such that at least one container contacts a stop positioned about the vend belt, retracting the vend belt further to an opened position such that at least one container falls off of the vend belt, and extending the vend belt back to the closed position.

The method further may include retracting the vend belt again to the opened position such that at least one container falls off of the vend belt and extending the vend belt again back to the closed position. The step of loading the container onto the vend belt may include loading the container onto a shelf system and rotating the shelf system until the container drops onto the vend belt. The step of retracting the vend belt may include spooling the vend belt on to a wheel. The step of extending the vend belt may include pulling the vend belt off of the wheel by a pulley system. The at least one container may include a number of containers such that a first one of the containers contacts the stop and a second one of the containers falls off the vend belt.

The present application further describes a vending machine for dispensing at least one container. The vending machine may include a vend belt and a pulley system for maneuvering the vend belt such that the container is positioned on the vend belt and dispensed by retracting the vend belt by the pulley system. The pulley system may include a first wheel, a second wheel, and a pulley belt. The vend belt system may include a stop positioned about the vend belt.

These and other features of the present application will become apparent to one of ordinary skill in the art upon review of the following detailed description when taken in conjunction with the drawings and the several appended claims.

### BRIEF DESCRIPTION OF THE DRAWINGS

FIG. 1 is a perspective view of a vending machine as is described herein.

FIG. 2 is a front view of the shelf system of the vending machine of FIG. 1.

FIGS. 3A-3D are front views of the shelf system in operation.

FIG. 4 is a perspective view of the vend belt system of the vending machine of FIG. 1.

FIGS. 5A-5F are side plan views showing the vend belt system in operation.

### DETAILED DESCRIPTION

The apparatuses and methods described herein are intended to be used with a number of containers 10. The containers 10 may be any type of object that is generally sold within a vending machine. The containers 10 may take any desired shape or size. Likewise, any number of the containers 10 may be used herein. The containers 10 may include bottles, cans, pouches, and the like. The containers 10 may contain beverages, foods, and the like. Any other type of merchandise may be used herein without limitation.

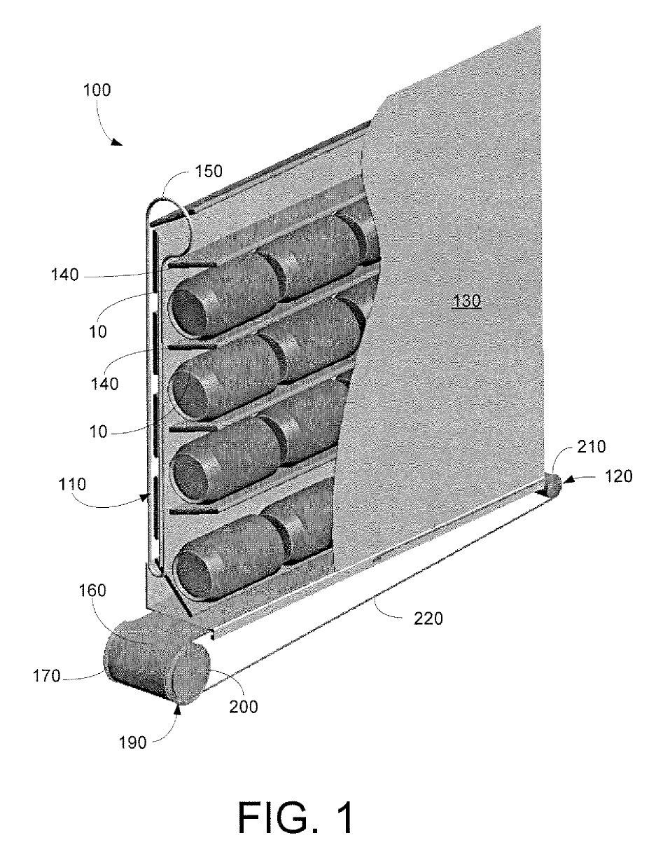

Referring now to the drawings in which like numerals refer to like elements throughout the several views, FIG. 1 shows a vending machine 100 as is described herein. The vending machine 100 may be used with any number of the containers 10 as described above.

Generally described, the vending machine 100 includes a shelf system 110 and a vend belt system 120. The shelf system 110 and the vend belt system 120 may be used with any number of other components of the vending machine 100. Specifically, the shelf system 110 and the vend belt system 120 may be used with a conventional frame, heating and/or refrigeration systems, selection systems, payment systems and any other type of conventional or desired component. The shelf system 110 and the vend belt system 120 may be a retrofit, in whole or in part, to an existing vending machine or the shelf system 110 and the vend belt system 120 may be provided with the vending machine 100 as original equipment.

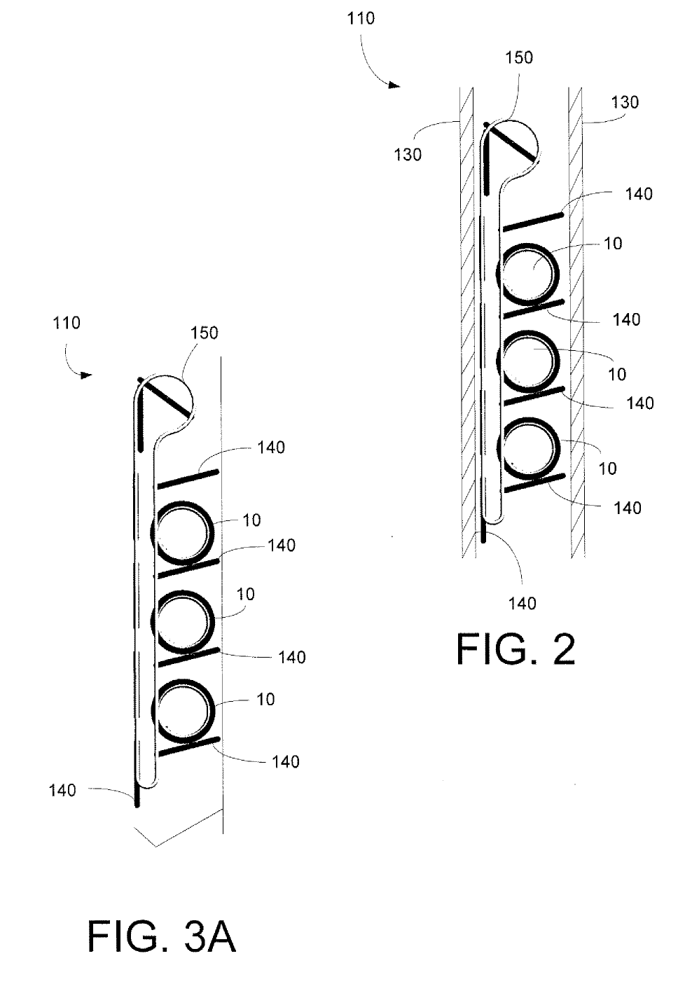

1191 FIG. 2 shows a front view of an example of the shelf system 110. The shelf system 110 may be positioned within a pair of columns 130 of the vending machine 100. The vending machine 100 thus may have a number of shelf systems 110 positioned therein depending upon the number of the columns 130. Further, the vending machine 100 may have a number of shelf systems 110 positioned in a number of the columns 130 and a number of conventional dispensing devices positioned in a number of other columns 130. Any number of the shelf systems 110 therefore may be used herein.

The shelf system 110 may include a number of shells or shelves 140. The shelves 140 may be made out of metal, plastic, or any type of material that is substantially corrosion resistant. Any number of shelves 140 may be used herein. The shelves 140 may be positioned on a belt 150. The belt 150 may be any type of circular or endless belt or chain. The belt 150 may have any desired length. A number of belts 150 may be used together with the shelves 140 attached to each. Each shelf 140 may be attached to the belt 150 via a hinge or other type of rotatable attachment. Each shelf 140 may be positioned in a largely inclined horizontal direction so as to load the containers 10 thereon and transport them downwardly towards the vend belt system 120. The shelf 140 may then rotate to a largely vertical direction once the containers 10 have been dispensed such that the shelf 140 returns back up to the top of the belt 150 in an endless loop.

The distance between the columns 130 determines the maximum width of each shelf 140 as well as the maximum diameter of the containers 10. Note that the maximum length of each shelf 140 (or the length of a combination of multiple shelves 140) is determined by the interior depth of the vending machine 100 as a whole. The spacing between the shelves 140 also may be varied as desired. The vertical distance between two shelves 140 determines the maximum height (and also the maximum diameter) of the containers 10. The vertical distance may be changed based upon the dimensions of the containers 10.

The belt 150 of the shelf system 110 may be motorized in a conventional fashion such that the belt 150 may rotate as desired. Alternatively, the belt(s) 150 may be fixed and a further belt 150 may be used to drive the shelves 140. A conventional DC motor or similar types of drive means may be used herein. The shelf system 110 and the vending machine 100 as a whole may be operated by conventional control means or otherwise.

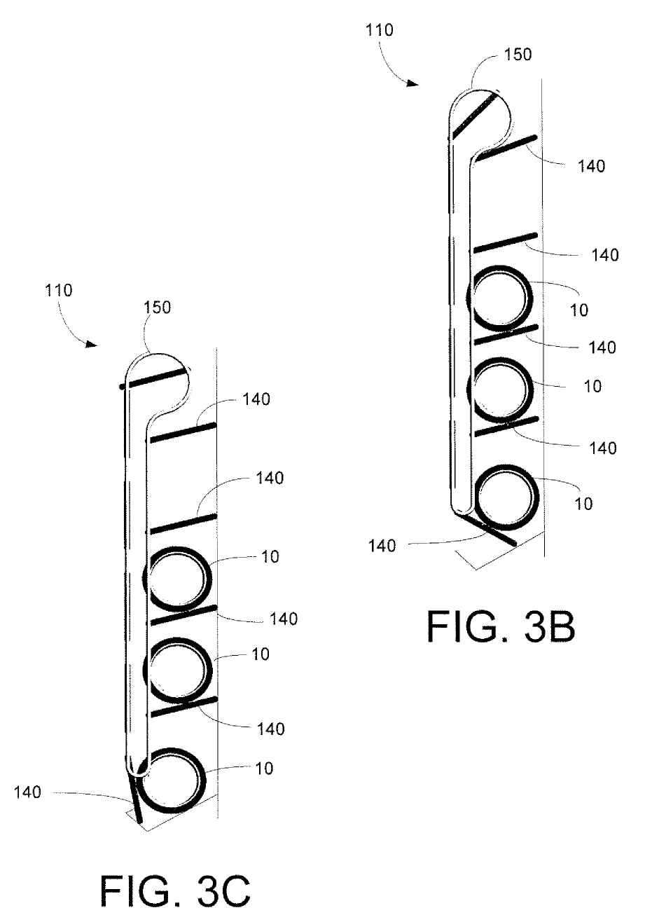

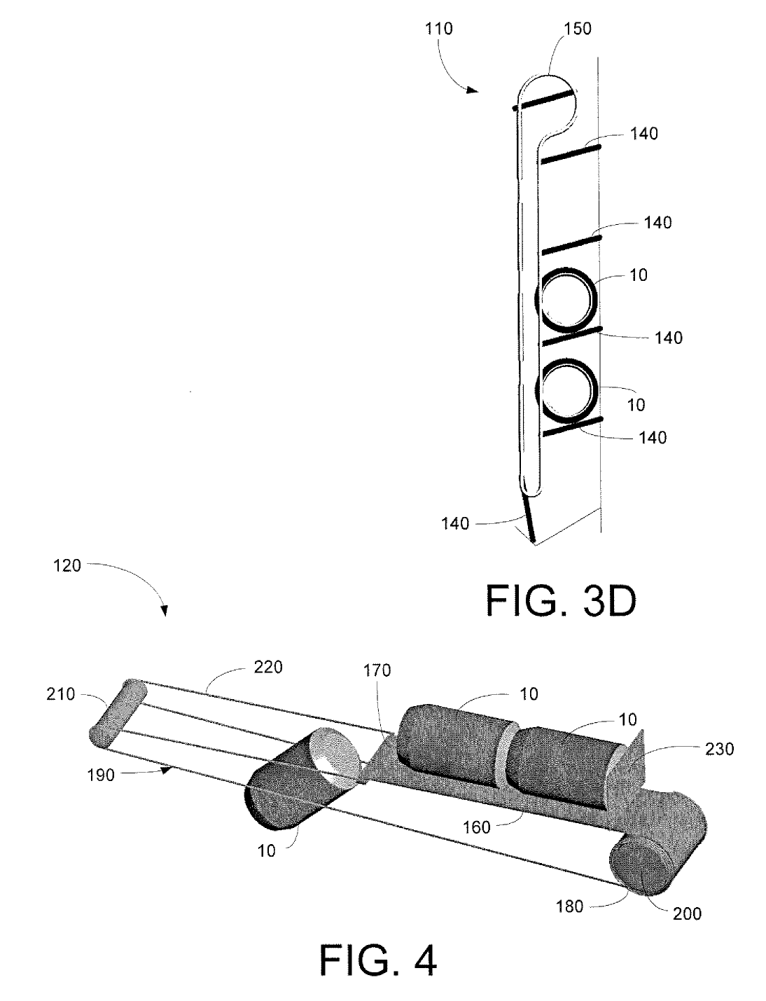

FIGS. 3A-3D show an example of the shelf system 110 in operation. As is shown, each shelf 140 may be loaded with a container 10. (Although only one (1) container 10 is shown given the front view, each shelf 140 may be loaded with any number of containers 10.) Once loaded, each shelf 140 descends downwardly towards the vend belt system 120. Once the shelf 140 reaches the lower return of the belt 150, the shelf 140 rotates downward and gently discharges the container(s) 10 onto the vend belt system 120. The shelf 140 is then rotated into its vertical position and gradually returns towards the top of the column 130. The shelf 140 then may be reloaded with the containers 10 and the process may continue indefinitely.

FIG. 4 shows the vend belt system 120. As is shown, the vend belt system 120 includes a vend belt 160. The vend belt 160 may be a band, a strip, a ribbon, and the like that can extend and retract as desired. The vend belt 160 may be made Out of any type of substantially corrosion resistant material. Specifically, the vend belt 160 may be made out of stainless steel (metal sheet of about 0.02 inches or about 0.5 millimeters), or similar types of materials. The vend belt 160 may have any desired length, width, or thickness. The vend belt 160 may have a first end 170 and a second end 180.

The vend belt 160 may be used with a pulley system 190. The pulley system 190 may include a first wheel 200 and a second wheel 210. The pulley system 190 further may include a pair of pulley belts 220. The pulley belts 220 may connect the wheels 200. 210 and the vend belt 160. Specifically, the first end 170 of the vend belt 160 may be spooled or retracted about the first wheel 200. The second end 180 of the vend belt 160 may be attached to the pulley belts 220. In turn, the pulley belts 220 are mounted around the second wheel 210 on one end and about the first end 170 of the vend belt 160 on the other. Other methods of advancing and retracting the vend belt 160 may be used herein.

Either or both the first wheel 200 and the second wheel 210 of the pulley system 190 may be mechanized so as to rotate the wheels 200, 210. Any type of conventional drive mechanism may be used herein such as a conventional DC motor or similar types of devices. As above, the vend belt system 120 and the vending machine 100 as a whole may have a conventional control system.

A stop 230 may be positioned about the first end 170 of the vend belt 160. The stop 230 may be positioned a predetermined distance off of the vend belt 160. The stop 230 may be any type of blunt, fixed surface and may be made out of metal, plastic, or any type of convenient materials. The stop 230 may be mounted or positioned adjacent to the vend belt 160 as desired.

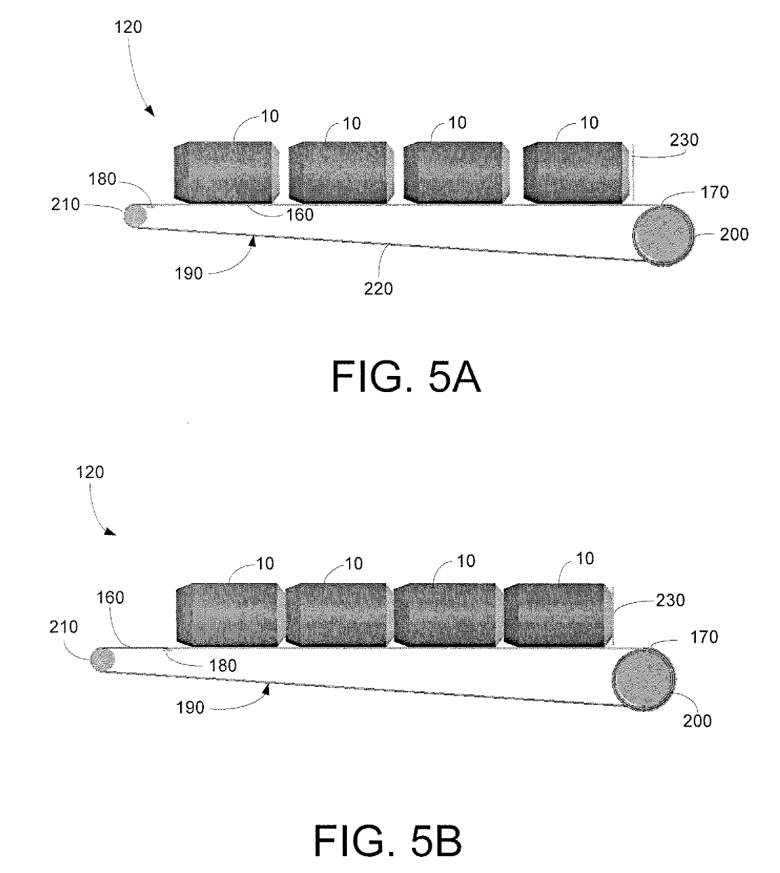

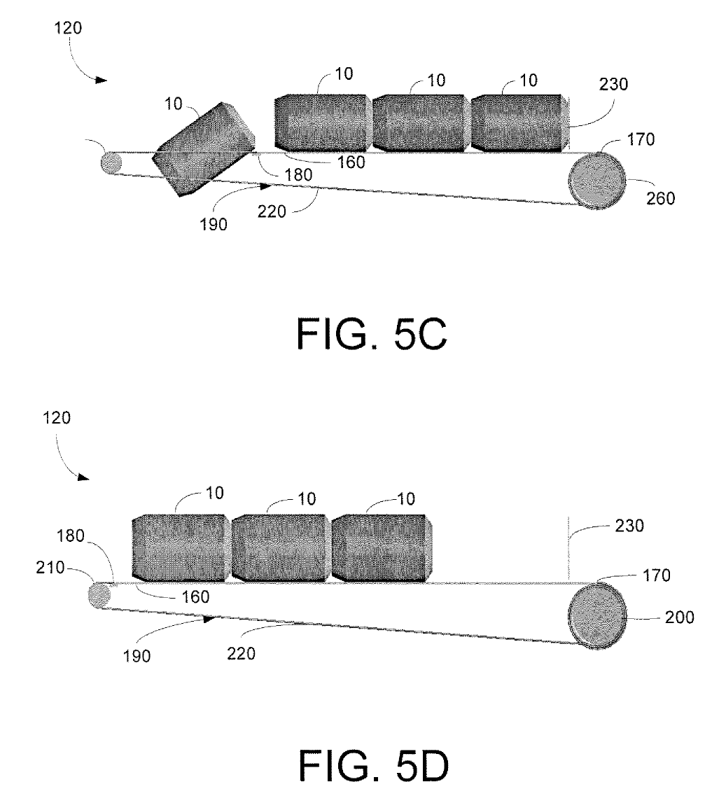

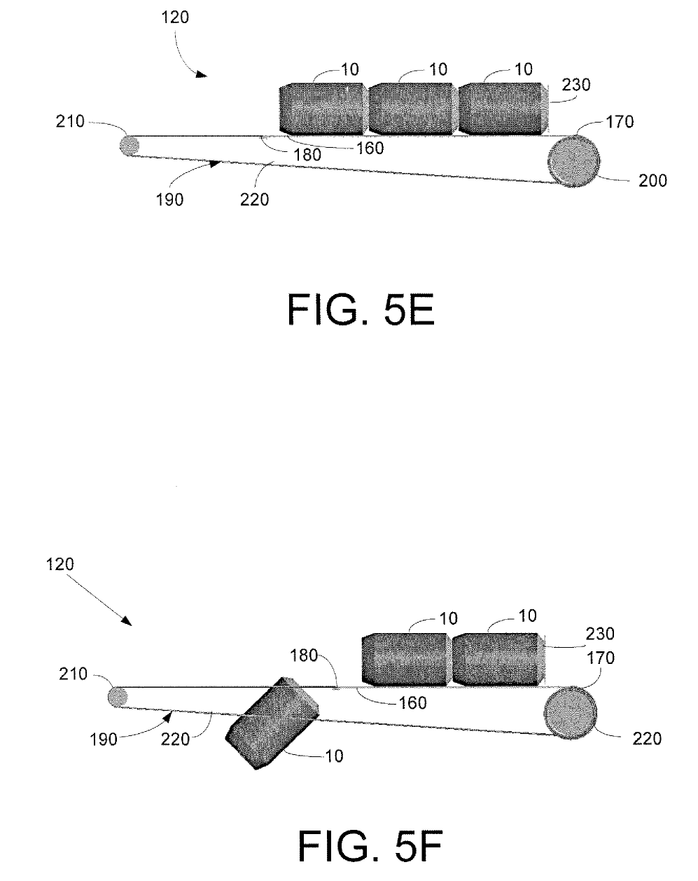

In use, the containers 10 may be positioned on the vend belt 160 largely without regard to spacing. Rather, the vend belt 160 itself operates to organize the containers 10 in a single file fashion. As is shown in FIGS. 5A-5F, any number of containers 10 may be loaded onto the vend belt 160 of the vend belt system 120. As the vend belt 160 begins to retract towards the first wheel 200, the containers 10 are forced against the stop 230. As the vend belt 160 continues to retract, the lead container 10 falls off of the vend belt 160. The container 10 is then dispensed in a conventional fashion. Once the first container 10 is dispensed, the vend belt 160 reverses direction and extends back towards the second wheel 210. By returning the vend bell 160 towards the second wheel 210, the loss of cold air or otherwise treated air about the shelf system 110 and the vend belt system 120 is minimized.

When the next container 10 is to be dispensed, the vend belt 160 again retracts towards the first wheel 200 such that the rear container 10 again contacts the stop 230. The vend belt 160 continues to retract such that the next container is then dispensed. The vend belt 160 then extends back towards the second wheel 210 so as to limit the loss of cool or otherwise treated air. The process will repeat itself until the vend belt 160 is empty. At that point, the shelf system 10 may be triggered so as to discharge the containers 10 of the next shelf 140 onto the vend belt 160. The extent of travel of the vend belt 160 may be predetermined. Alternatively, various types of sensors can be used to determine when the container 10 drops off of the vend belt 160 and when the vend belt 160 should be reloaded.

It should be apparent that the foregoing relates only to the preferred embodiments of the present application and that numerous changes and modification may be made herein by one of ordinary skill in the art without departing from the general spirit and scope of the invention as defined by the following claims and the equivalents thereof.

We claim:

1. A vending machine for dispensing a number of containers, comprising:
a shelf system; and
a vend belt system positioned about the shelf system.

2. The vending machine of claim 1, further comprising a plurality of shelf systems.

3. The vending machine of claim 1, wherein the shelf system comprises a plurality of shelves.

4. The vending machine of claim 3, wherein the plurality of shelves comprise a variable distance therebetween.

5. The vending machine of claim 3, wherein the shelf system comprises a belt with the plurality of shelves attached thereto.

6. The vending machine of claim 5, wherein the shelf system comprises a plurality of belts.

7. The vending machine of claim 3, wherein the shelf system comprises a top end and a bottom end and wherein the plurality of shelves extend substantially horizontally when traveling from the top end to the bottom end of the shelf system and substantially vertically when traveling from the bottom end to the top end.

8. The vending machine of claim 1, wherein the vend belt system comprises a vend belt.

9. The vending machine of claim 8, wherein the vend belt system comprises a pulley system for maneuvering the vend belt.

10. The vending machine of claim 9, wherein the pulley system comprises a first wheel, a second wheel, and a pulley belt.

11. The vending machine of claim 8, wherein the vend belt system comprises a stop positioned about the vend bell.

12. A method of vending at least one container, comprising:
loading at least one container onto a vend belt in a closed position;
retracting the vend belt such that at least one container contacts a stop positioned about the vend belt;
retracting the vend belt further to an opened position such that at least one container falls off of the vend belt; and
extending the vend belt back to the closed position.

13. The method of claim 12, further comprising retracting the vend belt again to the opened position such that at least one container falls off of the vend belt and extending the vend belt again back to the closed position.

14. The method of claim 12., wherein the step of loading at least one container onto the vend belt comprises loading at least one container onto a shelf system and rotating the shelf system until the container drops onto the vend belt.

15. The method of claim 12, wherein the step of retracting the vend belt comprises spooling the vend belt on to a wheel.

16. The method of claim 15, wherein the step of extending the vend belt comprises pulling the vend belt off of the wheel by a pulley system.

17. The method of claim 12, wherein the at least one container comprises a plurality of containers such that a first one of the plurality of containers contacts the stop and a second one of the plurality of containers falls off the vend belt.

18. A vending machine for dispensing at least one container, comprising a vend belt; and
a pulley system for maneuvering the vend belt such that at least one container is positioned on the vend belt and dispensed by retracting the vend belt by the pulley system.

19. The vending machine of claim 18, wherein the pulley system comprises a first wheel, a second wheel, and a pulley belt.

20. The vending machine of claim 18, wherein the vend belt system comprises a stop positioned about the vend belt.
